(19) United States
(12) Patent Application Publication
(10) Pub. No.: US 2004/0238791 A1
(43) Pub. Date: Dec. 2, 2004

(54) Reinforcement of the effect of optical brighteners by means of polymers

(76) Inventors: Simon Champ, Ludwigshafen (DE); Friedrich Linhart, Heidelberg (DE); Hans-Peter Kaub, Altrip (DE); Thierry Blum, Neustadt (DE); Simon Nord, Romerberg (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/487,775

(22) PCT Filed: Aug. 28, 2002
(86) PCT No.: PCT/EP02/09579

(30) Foreign Application Priority Data
Sep. 3, 2001 (DE) 101 42 887.1
Sep. 7, 2001 (DE) 101 44 131.2
Oct. 18, 2001 (DE) 101 50 895.6
Dec. 12, 2001 (DE) 101 61 157.9

(51) Int. Cl. C09K 11/02

(52) U.S. Cl. 252/301.35

(57) ABSTRACT

Pigment-free mixtures, containing a) at least one optical brightener and b) at least one (co)polymer, with at least one N-vinylcarboxamide incorporated in the polymer and/or at least one nitrogen-containing heterocyclic ring and/or which may form a nitrogen-containing heterocyclic ring.

Intensifying the effect of optical brighteners with the aid of polymers

The present invention relates to a process for intensifying the effect of optical brighteners with the aid of polymers.

Optical brighteners are used industrially in a large number of applications for improving the whiteness, for example in detergents, textiles, plastics, synthetic fibers or paper.

They are fluorescent whitening agents (fluorescent or phosphorescent dyes). These are dye-like, fluorescent compounds which absorb the short-wave ultraviolet light not visible to the human eye and emit it as longer-wave blue light, with the result that the human eye perceives greater whiteness and hence the whiteness is increased. The ultraviolet light absorbed from daylight has a wavelength of about 300-430 nm and is frequently reemitted by optical brighteners as blue light having a wavelength of 400-500 nm.

However, the use of optical brighteners leads to the desired success only when they are present in an optimum structure, conformation and distribution. In order to achieve this, for example, polymeric compounds which intensify the effect of the optical brightener and are referred to as activators or carriers are added to paper coating slips.

However, the fact that a large number of industrially used optical brighteners contain hydrophilic, for example sulfo, groups in order to improve their water solubility is problematic (cf. for example Ullmann's Encyclopedia of Industrial Chemistry, Sixth Edition, 2000 Electronic Release, OPTICAL BRIGHTENERS). In the form of sulfonic acids with anionic polymers or in the form of sulfonates with cationic polymers, which are suitable as activators, these form sparingly soluble agglomerates, so that a large number of polymers cannot be used as activators for this reason.

However, a monomolecular distribution of the optical brightener is desirable since aggregates of the brightener molecules can result in a reduction in the quantum yield and even a spectral shift (Ullmann's Encyclopedia of Industrial Chemistry, loc. cit., OPTICAL BRIGHTENERS—section entitled Physical Principles).

Typical frequently used activators are, for example, polyvinyl alcohol, carboxymethylcellulose, anionic or nonionic degraded starches, casein, soybean protein and (meth)acrylic acid/acrylate copolymers.

DE-A1 100 55 592 discloses pigmented paper coating slips which contain N-vinylformamide incorporated in the form of polymerized units as additives in polymers or copolymers and may furthermore contain 0.2-2 parts by weight of optical brightener per 100 parts by weight of pigment.

However, the concept described can be applied only to pigmented paper coating slips.

For applications other than paper applications, there is a constant need for activators for optical brighteners.

It is an object of the present invention to provide further activators for optical brighteners for applications other than paper applications.

We have found that this object is achieved by pigment-free mixtures comprising

a) at least one optical brightener and

b) at least one (co)polymer which contains at least one N-vinylcarboxamide incorporated in the form of polymerized units and/or contains at least one nitrogen-containing heterocyclic ring and/or is capable of forming a nitrogen-containing heterocyclic ring.

According to CD Römpp Chemie Lexikon—Version 1.0, Stuttgart/New York: Georg Thieme Verlag 1995, with reference to DIN 55943, pigments in the context of this document are particulate “inorganic or organic, colored or uncolored colorants practically insoluble in the application medium”.

Practically insoluble means a solubility at 25° C. of less than 1, preferably less than 0.5, particularly preferably less than 0.25, very particularly preferably less than 0.1, in particular less than 0.05, g/1000 g of application medium.

Pigment-free means a lower content of-pigment in the mixture than of optical brightener, i.e. not more than 1, preferably not more than 0.75, particularly preferably not more than 0.5, very particularly preferably not more than 0.25, in particular not more than 0.1, exceptionally preferably 0, part by weight of pigment per part by weight of optical brightener.

Suitable optical brighteners a) are the compounds known to a person skilled in the art for such purposes.

For example, those optical brighteners which have an absorption maximum in the wavelength range from 350 to 375 nm may be used, and the absorption band should decline at wavelengths above 400 nm. The fluorescence maximum of the optical brighteners should be in the wavelength range of 415-445 nm.

Optical brighteners may be, for example, those optical brighteners as mentioned in Ullmann's Encyclopedia of Industrial Chemistry, Sixth Edition, 2000 Electronic Release, OPTICAL BRIGHTENERS.

Suitable optical brighteners belong, for example, to the group consisting of the distyrylbenzenes, for example cyano-substituted 1,4-distyrylbenzenes having cyano groups in the 2′ and 3″ positions [CAS Reg. No. 79026-03-2] or in the 2′ and 2″ positions [13001-38-2], in the 3′ and 3″ positions [36755-00-7], in the 3′ and 4″ positions [79026-02-1] and in the 4′ and 4″ positions [13001-40-6], or amphoteric compounds, e.g. [84196-71-4], which each carry a

—O—(CH₂)₂⁻N⁺(C₂H₅)₂—CH₂COO—

group in the 2′ and 2″ positions, to the group consisting of the distyrylbiphenyls, for example, 4,4′-di(2-sulfostyryl)biphenyl disodium salt [27344-41-8], 4,4′-di(3-sulfostyryl)biphenyl disodium salt [51119-63-2], 4,4′-di(4-chloro-3-sulfostyryl)biphenyl disodium salt [42380-62-1], 4,4′-di(6-chloro-3-sulfostyryl)biphenyl disodium salt [60477-28-3], 4,4′-di(2-methoxystyryl)biphenyl [40470-68-6] or a 4,4′-di(styryl)biphenyl which carries a

—O—(CH₂)₂⁻N⁺(CH₃)(C₂H₅)₂.CH₃OSO₃—

group in the 2 position on the styryl radical [72796-88-4], to the group consisting of the divinylstilbenes, for example 4,4′-di(ethoxycarbonylvinyl)stilbene [60683-03-6] or 4,4′-di(cyanovinyl)stilbene [60682-87-3], to the group consisting of the triazinylaminostilbenes, e.g. 1,3,5-triazinyl derivatives of 4,4′-diaminostilbene-2,2′-disulfonic acid, such as anilino derivatives which carry the following radicals on the triazine rings in each case in the 3 position: a methoxy radical (CAS Reg. No. [3426-43-5]), aminomethyl [35632-99-6], ethylamino [24565-13-7], hydroxyethylamino [12224-16-7], N-hydroxyethyl-N-methylamino [13863-31-5], bis(hydroxyethyl)amino [4193-55-9], morpholino [16090-02-1], phenylamino [133-66-4] or N-2-aminocarbonylethyl-N-2-hydroxyethylamino [68444-86-0], or such as anilinosulfonic acid derivatives which carry the following radicals on the triazine rings in each case in the 3 position: N-hydroxyethylamino and, additionally on the anilino group present in the 5 position of the triazine ring, a sulfo group in the 3 position (CAS Reg. No. [61968-74-9]), N-bis(hydroxyethyl)amino and, additionally on the anilino group, a sulfo group in the 3 position (CAS Reg. No. [12224-02-1]), N-bis(2-hydroxypropyl)amino and, additionally on the anilino group, a sulfo group in the 4 position (CAS Reg. No. [99549-42-5]), N-bis(hydroxyethyl)amino and, additionally on the anilino group, a sulfo group in the 4 position (CAS Reg. No. [16470-24-9]), N-hydroxyethyl-N-methylamino and, additionally on the anilino group, a sulfo group in the 4 position (CAS Reg. No. [74228-28-7]), diethylamino and, additionally on the anilino group, sulfo groups in the 2 and 5 positions (CAS Reg. No. [83512-97-4]), N-bis(hydroxyethyl)amino and, additionally on the anilino group, sulfo groups in the 2 and 5 positions (CAS Reg. No. [76482-78-5]), or morpholino groups and, additionally on the anilino group, sulfo groups in the 2 and 5 positions (CAS Reg. No. [55585-28-9]), or to the group consisting of the stilbenyl-2H-triazoles, e.g. stilbenyl-2H-naphtho[1,2-d]triazoles, such as the sodium salt of 4-(2H-naphtho[1,2-d]triazol-2-yl)stilbene-2-sulfonic acid [6416-68-8] or those which carry a sulfo group in the 6 position on the naphthol ring and in the 2 position of the stilbene skeleton [2583-80-4], or a cyano group in the 2 position on the stilbene skeleton and a chloro group in the 4′ position [5516-20-1], or e.g. bis(1,2,3-triazol-2-yl)stilbenes, such as 4,4′-bis(4-phenyl-1,2,3-triazol-2-yl)stilbene-2,2′-disulfonic acid dipotassium salt [52237-03-3] or 4,4′-bis(4-(4′-sulfophenyl)-1,2,3-triazol-2-yl)stilbene-2,2′-disulfonic acid tetrasodium salt [61968-72-7], or to the group consisting of the benzoxazoles, e.g. stilbenylbenzoxazoles, for example 5,7-dimethyl-2-(4′-phenylstilben-4-yl)benzoxazole [40704-04-9], 5-methyl-2-(4′-(4″-methoxycarbonyl)phenylstilben-4-yl)benzoxazole [18039-18-4], or those which carry other heterocycles in the 4″ position, e.g. [64893-28-3], or bis(benzoxazoles), e.g. ethylene-, thiophene-, naphthylene-, phenylethylene- or stilbene-bridged bisbenzoxazoles, such as those having the CAS numbers [1041-00-5], [2866-43-5], [7128-64-5], [5089-22-5], [1552-46-1], [1533-45-5] and [5242-49-9].

It is furthermore possible to use furans, benzo[b]furans and benzimidazoles, e.g. bis(benzo[b]furan-2-yl)biphenyls, for example sulfonated 4,4′-bis(benzo[b]furan-2-yl)biphenyls, or cationic benzimidazoles, for example 2,5-di(1-methylbenzimidazol-2-yl)furan [4751-43-3], [72829-17-5], [74878-56-1], [74878-48-1] or [66371-25-3], or 1,3-diphenyl-2-pyrazolines, e.g. 1-(4-amidosulfonylphenyl)-3-(4-chlorophenyl)-2-pyrazoline [2744-49-2], [60650-43-3], [3656-22-2], [27441-70-9], [32020-25-0], [61931-42-8] or [81209-71-4], and tertiary and quaternary amine salts of 1,3-diphenyl-2-pyrazoline derivatives, e.g. [106359-93-7], [85154-08-1], [42952-22-7], [63310-12-3], [12270-54-1] or [36086-26-7], and coumarins, e.g. 7-diethylamino-4-methylcoumarin [91-44-1] or [6025-18-9], [19683-09-1], [3333-62-8], [63660-99-1], [26867-94-7] or [52725-14-1], and naphthalimides, e.g. 4-Acetylamino-N-(n-butyl)naphthalimide [3353-99-9], 4-methoxy-N-methylnaphthalimide [3271-05-4], [3271-05-4], [22330-48-9], [25826-31-7], [26848-65-7] or [60317-11-5], and 1,3,5-triazin-2-yl derivatives, for example (4,6-dimethoxy-1,3,5-triazin-2-yl)pyrene [3271-22-5] or 4,4′-di(4,6-diphenyl-1,3,5-triazin-2-yl)stilbene [6888-33-1].

Among these optical brighteners, those which carry at least one, preferably from one to 6, particularly preferably from 2 to 6, in particular 2, 4 or 6, sulfo groups are preferred.

Particularly preferred optical brighteners are those having at least one stilbene parent structure (E- or Z-C₆H₅—CH═CH—C₆H₅, where the phenyl radicals C₆H₅ can of course be mono- or polysubstituted), i.e. said 1,4-distyrylbenzenes, distyrylbiphenyls, divinylstilbenes, triazinylaminostilbenes, stilbenyl-2H-triazoles, stilbenyl-2H-naphtho[1,2-d]triazoles, bis(1,2,3-triazol-2-yl)stilbenes and stilbenylbenzoxazoles.

Particularly preferred optical brighteners are those which have at least one stilbene parent structure and additionally carry at least one, preferably from one to 6, particularly preferably from 2 to 6, in particular 2, 4 or 6, sulfo groups.

4,4′-Distyrylbiphenyl derivatives or stilbene derivatives which are substituted by up to 6, particularly preferably by 2, 4 or 6, sulfo groups can very particularly preferably be used, preferably the Blankophor® brands from Bayer AG, among these in particular Blankophor® BA, P, PUL and Blankophor® PSG; the Tinopal® brands from Ciba Specialty Chemicals are furthermore preferred, among these in particular Tinopal® MC liquid, Tinopal® ABP-Z liquid, Tinopal® SPP-Z liquid and Tinopal® SK-B liquid, and furthermore preferred are the Leukophor® brands from Clariant AG, among these in particular Leukophor® APN, UO, NS or SHR.

Of course, it is also possible to use a plurality of different optical brighteners, for example two, three or four, one or two being preferably used, particularly preferably one.

The optical brighteners used can be employed in the form of solids, for example as powders or granules, in the form of solutions, for example as aqueous or alcoholic, e.g. ethanolic, solution, or in the form of a slurry, for example a suspension, e.g. in water.

According to the invention, at least one (co)polymer which contains at least one N-vinylcarboxamide incorporated in the form of polymerized units and/or contains at least one nitrogen-containing heterocyclic ring and/or is capable of forming a nitrogen-containing heterocyclic ring is present as component b).

In this document, the term (co)polymer is used as an abbreviated notation for polymers and copolymers.

According to the invention, it is important that the (co)polymer used contain at least one N-vinylcarboxamide incorporated in the form of polymerized units and/or contain a nitrogen-containing heterocyclic ring and/or be capable of forming a nitrogen-containing heterocyclic ring.

Heterocyclic rings may be, for example, five-, six- or seven-membered, preferably five- or six-membered, particularly preferably six-membered, rings.

In addition to carbon and hydrogen atoms, the heterocyclic rings contain at least one nitrogen atom, preferably from one to four, particularly preferably from one to three, very particularly preferably one or two, nitrogen atoms, in particular one nitrogen atom. If required, further hetero atoms, e.g. oxygen, sulfur, phosphorus or halogen atoms, may also be present, but preferably no further hetero atoms are present.

The nitrogen-containing heterocyclic rings may be, for example, pyridines, pyridazines, pyrazines, pyrimidines and the dihydro, tetrahydro- and hexahydro derivatives thereof, imidazoles, pyrroles, pyrrolidines, pyrrolidones, pyrrolines (dihydropyrroles), 1H-, 3H- or ⁻4H-pyrazoles, 1-, 2- or 3-pyrazolines, imidazolines, thiazoles, oxazoles, 1,2,4-triazoles and 1,2,3-triazoles.

Imidazoles, 2-pyrrolidones, pyrimidines and 3,4,5-6-tetrahydropyrimidines are preferred.

Such (co)polymers are obtainable, for example, by (co)polymerization of monomers which contain the relevant heterocyclic rings. Examples of these are N-vinylimidazole and N-vinylpyrrolidone.

The content of such monomers incorporated in the form of polymerized units in the (co)polymer is, for example, from 10 to 100, preferably from 30 to 100, particularly preferably from 50 to 100, very particularly preferably from 75 to 100, in particular 100, mol %, in addition to further monomers, for example ii) and iii) mentioned below.

Polyvinylpyrrolidone and polyvinylimidazole are preferred.

Very particularly preferred (co)polymers are those which contain an amidine structure of the formula (II):

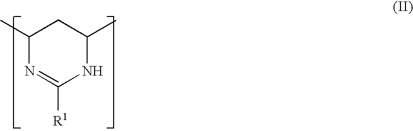

Therein, R¹ has the meanings stated below for formula (I).

The protonated or, if required, quaternized forms of the heterocyclic rings are also included here.

Such heterocyclic rings having an amidine structure are also capable of forming in a (co)polymer in which the monomers used contain no heterocycles, for example with elimination of water from a partly cleaved (see below) (co)polymer which contains N-vinylcarboxamide incorporated in the form of polymerized units:

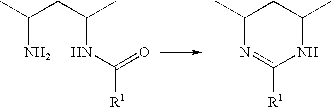

The presence of such 3,4,5,6-tetrahydropyrimidine structures can be checked by NMR, since they typically exhibit NMR signals in the range of about 150-160 ppm (¹³C-NMR, d₆-acetone, R¹=H), preferably 152-156 ppm, particularly preferably about 154 ppm, while the corresponding open-chain carboxamido group exhibits a signal at about 167 ppm.

In general, (co)polymers which can be used according to the invention may also contain at least one N-vinylcarboxamide incorporated in the form of polymerized units.

For example, they may contain

i) at least one N-vinylcarboxamide

ii) if required, at least one water-soluble cationic monomer

iii) if required, at least one further monomer incorporated in the form of polymerized units.

Suitable N-vinylcarboxamides i) are preferably those of the formula (I).

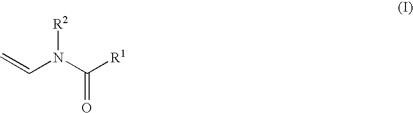

In formula I, R¹ and R², independently of one another, are hydrogen or C₁- to C₂₀-alkyl, it being possible for the alkyl radical to be straight-chain or branched.

R¹ and R², independently of one another, are preferably hydrogen or C₁- to C₁₀-alkyl, particularly preferably hydrogen or C₁- to C₄-alkyl, very particularly preferably hydrogen or methyl, in particular hydrogen.

R¹ and R² together may also form a straight or branched chain containing 2 to 8, preferably 3 to 6, particularly preferably 3 to 5, carbon atoms. If required, one or more carbon atoms may be replaced by hetero atoms, e.g. oxygen, nitrogen or sulfur.

Examples of the radicals R¹ and R² are methyl, ethyl, isopropyl, n-propyl, n-butyl, isobutyl, sec-butyl, tert-butyl, n-hexyl, n-heptyl, 2-ethylhexyl, n-octyl, n-decyl, n-undecyl, n-dodecyl, n-tetradecyl, n-hexadecyl, n-octadecyl and n-eicosyl.

Examples of radicals R¹ and R² which together form a chain are 1,2-ethylene, 1,2-propylene, 1,3-propylene, 2-methyl-1,3-propylene, 2-ethyl-1,3-propylene, 1,4-butylene, 1,5-pentylene, 2-methyl-1,5-pentylene, 1,6-hexylene and 3-oxa-1,5-pentylene.

Examples of such N-vinylcarboxamides according to formula (I) are N-vinylformamide, N-vinylacetamide, N-vinylpropionamide, N-vinylbutyramide, N-vinylisobutyramide, N-vinyl-2-ethylhexanamide, N-vinyldecanamide, N-vinyldodecanamide, N-vinlystearamide, N-methyl-N-vinylformamide, N-methyl-N-vinylacetamide, N-methyl-N-vinylpropionamide, N-methyl-N-vinylbutyramide, N-methyl-N-vinylisobutyramide, N-methyl-N-vinyl-2-ethylhexanamide, N-methyl-N-vinyldecanamide, N-methyl-N-vinyldodecanamide, N-methyl-N-vinylstearamide, N-ethyl-N-vinylformamide, N-ethyl-N-vinylacetamide, N-ethyl-N-vinylpropionamide, N-ethyl-N-vinylbutyramide, N-ethyl-N-vinylisobutyramide, N-ethyl-N-vinyl-2-ethylhexanamide, N-ethyl-N-vinyldecanamide, N-ethyl-N-vinyldodecanamide, N-ethyl-N-vinylstearamide, N-isopropyl-N-vinylformamide, N-isopropyl-N-vinylacetamide, N-isopropyl-N-vinylpropionamide, N-isopropyl-N-vinylbutyramide, N-isopropyl-N-vinylisobutyramide, N-isopropyl-N-vinyl-2-ethylhexanamide, N-isopropyl-N-vinyldecanamide, N-isopropyl-N-vinyldodecanamide, N-isopropyl-N-vinylstearamide, N-n-butyl-N-vinylformamide, N-n-butyl-N-vinylacetamide, N-n-butyl-N-vinylpropionamide, N-n-butyl-N-vinylbutyramide, N-n-butyl-N-vinylisobutyramide, N-n-butyl-N-vinyl-2-ethylhexanamide, N-n-butyl-N-vinyldecanamide, N-n-butyl-N-vinyldodecanamide, N-n-butyl-N-vinylstearamide, N-vinylpyrrolidone and N-vinylcaprolactam.

N-Vinylformamide, N-vinylacetamide, N-methyl-N-vinylformamide, N-methyl-N-vinylacetamide, N-vinylpyrrolidone and N-vinylcaprolactam are preferred, and N-vinylformamide is particularly preferred.

As water-soluble cationic monomer ii), it is possible to copolymerize cationic groups, e.g. ammonium, sulfonium or phosphonium groups, and monomers carrying at least one copolymerizable, ethylenically unsaturated group, for example diallyldimethylammonium chloride, diallyldimethylammonium methosulfate, N-(2-trimethylammonium)ethylacrylamide methosulfate or N-2-(ethyldimethyl)ammoniumethylmethacrylamide ethosulfate, or mixtures thereof, with the N-vinylcarboxamide i), as described, for example, in EP-B1 464 043 and cationic polymers are obtained thereby.

The further monomers iii) are selected from C₁- to C₂₀-alkyl (meth)acrylates, vinyl esters of carboxylic acids of up to 20 carbon atoms, vinylaromatics of up to 20 carbon atoms, ethylenically unsaturated nitriles, vinyl halides, vinyl ethers or allyl ethers of alcohols containing 1 to 10 carbon atoms, aliphatic hydrocarbons having 2 to 8 carbon atoms and 1 or 2 double bonds, α,β-unsaturated carboxylic acids of up to 10 carbon atoms or mixtures of these monomers.

Examples of alkyl (meth)acrylates are alkyl (meth)acrylates having a C₁-C₁₀-alkyl radical, such as methyl methacrylate, ethyl methacrylate, methyl acrylate, n-butyl acrylate, n-octyl acrylate, ethyl acrylate and 2-ethylhexyl acrylate.

In this document, (meth)acrylic acid is used for acrylic acid and methacrylic acid.

Mixtures of the alkyl (meth)acrylates are also particularly suitable.

Vinyl esters of carboxylic acids of 1 to 20 carbon atoms are, for example, vinyl laurate, vinyl stearate, vinyl propionate, vinyl versatate and preferably vinyl acetate.

Suitable vinylaromatic compounds are vinyltoluene, α- and p-methylstyrene, α-butylstyrene, 4-n-butylstyrene, 4-n-decylstyrene and preferably styrene.

Examples of nitriles are acrylonitrile and methacrylonitrile.

The vinyl halides are chlorine-, fluorine- or bromine-substituted ethylenically unsaturated compounds, preferably vinyl chloride and vinylidene chloride.

Examples of vinyl ethers are vinyl methyl ether, vinyl ethyl ether and vinyl isobutyl ether. Vinyl ethers of alcohols containing 1 to 4 carbon atoms are preferred.

Examples of hydrocarbons having 2 to 8 carbon atoms and one or two olefinic double bonds are butadiene, isoprene and chloroprene, ethylene and propylene.

α,β-Unsaturated carboxylic acids of up to 10 carbon atoms may be, for example, monoethylenically unsaturated carboxylic acids of 3 to 8 carbon atoms and the water-soluble salts of these monomers, for example: acrylic acid, methacrylic acid, dimethylacrylic acid, ethacrylic acid, maleic acid, citraconic acid, methylenemalonic acid, allylacetic acid, vinylacetic acid, crotonic acid, fumaric acid, mesaconic acid and itaconic acid. From this group of monomers, acrylic acid, methacrylic acid, maleic acid or mixtures of said carboxylic acids,-in particular mixtures of acrylic acid and maleic acid or mixtures of acrylic acid and methacrylic acid, are preferably used. These monomers or mixtures thereof can be used either in the form of the free carboxylic acids or in a form partially or completely neutralized with ammonium, alkali or alkaline earth metal ions, such as ammonium, trimethylammonium, triethylammonium, tris(2-hydroxyethyl)ammonium, bis(2-hydroxyethyl)ammonium, mono(2-hydroxyethyl)ammonium, trimethylbenzylammonium, sodium, potassium, magnesium, calcium or barium, in the copolymerization.

Preferred further monomers are the C₁- to C₁₀-alkyl acrylates and methacrylates, in particular C₁- to C₈-alkyl acrylates and methacrylates, the acrylates being particularly preferred in each case.

Very particularly preferred further monomers iii) are styrene, butadiene, acrylonitrile, vinyl acetate, acrylic acid, methyl acrylate, methyl methacrylate, ethyl acrylate, n-butyl acrylate, n-hexyl acrylate, octyl acrylate and 2-ethylhexyl acrylate and mixtures of these monomers.

The (co)polymers generally have the following composition:

i) from 30 to 100% by weight of at least one N-vinylcarboxamide,

ii) from 0 to 20% by weight of at least one water-soluble cationic monomer and

iii) from 0 to 60% by weight of at least one further monomer, or mixtures thereof,

with the proviso that the sum is always 100% by weight.

Preferred (co)polymers are those which have the following composition:

i) from 35 to 100% by weight of at least one N-vinylcarboxamide,

ii) from 0 to 10% by weight of at least one water-soluble cationic monomer and

iii) from 0 to 55% by weight of at least one further monomer, or mixtures thereof,

with the proviso that the sum is always 100% by weight.

Particularly preferred (co)polymers are those which have the following composition:

i) from 50 to 100% by weight of at least one N-vinylcarboxamide,

ii) from 0 to 5% by weight of at least one water-soluble cationic monomer and

iii) from 0 to 45% by weight of at least one further monomer, or mixtures thereof,

with the proviso that the sum is always 100% by weight.

Very particularly preferred (co)polymers are those which contain 100% by weight of at least one N-vinylcarboxamide incorporated in the form of polymerized units, in particular those which contain 100% by weight of N-vinylformamide incorporated in the form of polymerized units.

The molecular weight of the (co)polymers which may be used is not limited. (Co)polymers having K values of from 20 to 110 are preferred, K values of from 30 to 80 being particularly preferred.

In this document, the K values are measured according to Fikentscher in 0.5% strength by weight aqueous sodium chloride solution at 25° C.

The preparation of the polymers of N-vinylformamide, as can be used as (co)polymer, has long been known (cf. for example EP-B1 71 050).

A frequent method, but not the only one, for the preparation of the (co)polymer mentioned so far, preferably of the (co)polymers, is free radical (co)polymerization in a solvent or diluent.

The free radical (co)polymerization of the monomers is effected, for example, in an aqueous solution in the presence of polymerization initiators which decompose into free radicals under the polymerization conditions. The (co)polymerization can be carried out in a wide temperature range, if required under reduced or superatmospheric pressure, as a rule at up to 100° C. The pH of the reaction mixture is usually brought to from 4 to 10.

However, the (co)polymerization can also be carried out in another manner known per se to a person skilled in the art, for example as a solution, precipitation, water-in-oil emulsion or inverse suspension polymerization. Solution polymerization is preferred.

The monomer is (co)polymerized with the use of free radical polymerization initiators, e.g. peroxides, such as dibenzoyl peroxide or hydrogen peroxide, persulfates, such as sodium, potassium and ammonium persulfate or peroxosulfate, hydroperoxides, such as tert-butyl hydroperoxide or peroxyacetic acid, redox initiators, such as H₂O₂/ascorbic acid, or azo compounds which decompose to give free radicals, such as 2,2′-azobisisobutyronitrile, 2,2′-azobis(2-amidinopropane)hydrochloride or 4,4′-azobis(4′-cyanopentanoic acid).

Reduction-oxidation (redox) initiator systems are particularly suitable.

The redox initiator systems consist of at least one generally inorganic reducing agent and one inorganic or organic oxidizing agent.

The oxidizing component is, for example, one of the abovementioned initiators.

The reducing components are, for example, alkali metal salts of sulfurous acid, such as sodium sulfite or sodium bisulfite, alkali metal salts of disulfurous acid, such as sodium disulfite, bisulfite addition compounds of aliphatic aldehydes and ketones, such as acetone bisulfite, or reducing agents, such as hydroxymethanesulfinic acid and salts thereof, or ascorbic acid. The redox initiator systems can be used in the presence of soluble metal compounds whose metallic components can occur in a plurality of valency states.

Conventional redox initiator systems are, for example, ascorbic acid/iron (II) sulfate/sodium peroxodisulfate, tert-butyl hydroperoxide/sodium disulfite or tert-butyl hydroperoxide/sodium hydroxymethanesulfinate. The individual components, for example the reducing component, may also be mixtures, for example a mixture of the sodium salt of hydroxymethanesulfinic acid and sodium disulfite.

Said monomers are generally used in the form of aqueous solutions or dispersions, the lower concentration being determined by the amount of water acceptable in the (co)polymerization and the upper concentration by the solubility or dispersibility of the relevant compound in water. In general, the concentration is from 0.1 to 30, preferably from 0.5 to 20, particularly preferably from 1.0 to 10, % by weight, based on the solution, or, in the case of a dispersion, 10-80, preferably 10-70, particularly preferably from 20 to 60, % by weight.

The amount of the initiators is in general from 0.1 to 10, preferably from 0.5 to 5, % by weight, based on the monomers to be (co)polymerized. A plurality of different initiators may also be used in the (co)polymerization.

For example, water, alcohols, such as methanol, ethanol, n-propanol, isopropanol, n-butanol or isobutanol, or ketones, such as acetone, ethyl methyl ketone, diethyl ketone or isobutyl methyl ketone, may serve as solvents or diluents.

If required, the (co)polymerization can be carried out in the presence of polymerization regulators, for example hydroxylammonium salts, chlorinated hydrocarbons and thio compounds, such as tert-butyl mercaptan, ethyl thioglycolate, mercaptoethanol, mercaptopropyltrimethoxysilane, dodecyl mercaptan or tert-dodecyl mercaptan, or alkali metal hypophosphites. These regulators can be used in the (co)polymerization, for example, in amounts of from 0 to 0.8 part by weight, based on 100 parts by weight of the monomers to be (co)polymerized, by which the molar mass of the resulting (co)polymer is reduced.

Ionic and/or nonionic emulsifiers and/or protective colloids or stabilizers can be used as surface-active compounds in the emulsion polymerization.

Depending on the polymerization conditions, (co)polymers having different molecular weights are obtained in the (co)polymerization. (Co)polymers having a high K value, e.g. above 80, are preferably prepared by (co)polymerization of the N-vinylcarboxamide in water. (Co)polymers having a high K value are furthermore obtained, for example, by (co)polymerization of the monomers in the form of inverse suspension polymerization or by (co)polymerization of the monomers by the water-in-oil polymerization method.

In the inverse suspension polymerization method and the water-in-oil polymerization, saturated hydrocarbons, for example hexane, heptane, cyclohexane-or decalin, or aromatic hydrocarbons, such as benzene, toluene, xylene and cumene, are used as the oil phase. The ratio of oil phase to aqueous phase in the inverse suspension polymerization is, for example, from 10:1 to 1:10.

A (co)polymer having a low K value, e.g. below 80, is obtained if the (co)polymerization is carried out in the presence of polymerization regulators or in a solvent which regulates the (co)polymerization, e.g. alcohols, such as methanol, ethanol, n-propanol or isopropanol, or ketones, such as acetone, ethyl methyl ketone, diethyl ketone or isobutyl methyl ketone.

Correspondingly low K values are furthermore obtained with the aid of the conventional methods, i.e. the use of relatively large amounts of polymerization initiator or the use of polymerization regulators or combinations of said measures.

The (co)polymers containing N-vinylcarboxamides, for example of the formula (I), and in particular N-vinylformamide, incorporated in the form of polymerized units, are used, according to the invention, in partially cleaved form, i.e. the carboxyl group of the formula R¹—CO— is eliminated from the carboxamide. A degree of hydrolysis (degree of cleavage) of the carboxyl group of from 0 to 90 mol % is preferred, particularly preferably from 1 to 50, very particularly preferably from 1 to 30, in particular from 2 to 15, mol %, based on the N-carboxamide units contained in the (co)polymer. The method of elimination of the carboxyl or formyl group is not limited and can be effected, or example, in the presence of acid or base, the cleavage in the presence of bases, for example sodium hydroxide, potassium hydroxide, alkaline earth metal hydroxides, ammonia or amines, being preferred. Amphoteric (co)polymers can form thereby by partial hydrolysis, for example of a copolymer containing (meth)acrylates and N-alkyl-N-vinylcarboxamides incorporated in the form of polymerized units.

Cationic polymers of N-vinylformamide are obtained in a particularly simple manner by cleaving homopolymers of N-vinylformamide hydrolytically with defined amounts of acid or base to the desired degree of hydrolysis, as described in EP-B1 071 050. The amino groups formed thereby on the polymer chain are more or less protonated, depending on the pH of the solution, and thus impart a greater or lesser cationic character to the polymer.

If elimination of the carboxyl group is desired after the (co)polymerization, this can be carried out, for example, in water.

The elimination of the carboxyl group in the hydrolysis is effected at from 20 to 200° C., preferably at from 40 to 180° C., in the presence of acids or bases. The hydrolysis in the presence of acids or bases is particularly preferably carried out in a temperature range of from 70 to 90° C.

From about 0.05 to 1.5 equivalents of an acid, such as hydrochloric acid, hydrobromic acid, phosphoric acid or sulfuric acid, per carboxyl group equivalent in the poly-N-vinylcarboxamide are required for the acidic hydrolysis. The pH in the acidic hydrolysis is from 2 to 0, preferably from 1 to 0. The hydrolysis of N-vinylformamide takes place substantially more rapidly than that of (co)polymers of other N-vinylcarboxamides, for example of N-methyl-N-vinylformamide, and can therefore be carried out under milder conditions, i.e. at lower temperatures and without a large excess of acids.

In addition, the hydrolysis of the carboxyl groups of the poly-N-vinylcarboxamide can also be carried out in an alkaline medium, for example at a pH of from 11 to 14. This pH is preferably established by adding alkali metal bases, e.g. sodium hydroxide solution or potassium hydroxide solution. However, it is also possible to use ammonia, amines and/or alkaline earth metal bases. From 0.05 to 1.5 equivalents of a base are used for the alkaline hydrolysis, from 0.4 to 1.0 equivalent being preferred.

The cleavage can also be carried out at high temperatures, for example above 100° C., preferably from 120 to 180° C., particularly preferably from 140 to 160° C., in the presence of a solvent, e.g. water, without acid or base. This is preferably carried out under conditions above the critical point, for example using supercritical water.

In the hydrolysis (i.e. the carboxyl group is eliminated from the poly-N-vinylcarboxamide in water in the presence of acids or bases), a carboxylic acid, for example formic acid, or a salt thereof is obtained as a byproduct.

The solutions thus obtainable can be used in the novel process without further working-up, but the hydrolysis or the solvolysis products can also be separated off.

For example, the solutions obtained are treated with ion exchangers for the separation. The residue separated from the hydrolysis products can then be used according to the invention.

The water solubility of the (co)polymers which can be used according to the invention and contain N-vinylcarboxamides incorporated in the form of polymerized units is as a rule from at least 1% by weight-to complete solubility at 20° C.

If required, a solvent c) may also be present in the novel mixtures.

Examples of suitable solvents are water, methanol, ethanol, isopropanol, n-propanol, n-butanol, dimethylformamide and N-methylpyrrolidone, water or ethanol being preferred and water being particularly preferred.

Novel pigment-free mixtures comprise, for example,

a) at least one optical brightener,

b) at least one (co)polymer which contains at least one nitrogen-containing heterocyclic ring and/or is capable of forming a nitrogen-containing heterocyclic ring,

c) if required, a solvent,

d) if required, at least one surfactant and

e) if required, at least one dye.

The novel mixtures may be present in the form of solids, for example as powders or granules, in the form of solutions, for example as an aqueous or alcoholic solution, or in the form of a dispersion, for example as a suspension, e.g. in water, methanol or ethanol.

Typical pigment-free mixtures have the following composition:

a) 0.1 ppm by weight −5% by weight, preferably 0.1 ppm by weight −3% by weight, particularly preferably 0.2 ppm by weight −2% by weight, very particularly preferably 0.5 ppm by weight −1% by weight, in particular 1 ppm by weight −0.5% by weight, of optical brightener,

b) 5 ppm by weight −20% by weight, preferably 5 ppm by weight −10% by weight, particularly preferably 10 ppm by weight −5% by weight, very particularly preferably 10 ppm by weight −2% by weight, in particular 50 ppm by weight −1% by weight, of (co)polymer,

c) 0-99.99949, preferably 0-99.99898, particularly preferably 0-99.99895, very particularly preferably 0-99.9949, % by weight of solvent,

d) 0-50% by weight of surfactant and

e) 0-50% by weight of dye,

with the proviso that the sum is always 100% by weight.

Preferred novel mixtures are those in which d) and/or e) are present.

Particularly preferred novel pigment-free mixtures are those which consist of the components

a) at least one optical brightener,

b) at least one (co)polymer which contains at least one nitrogen-containing heterocyclic ring and/or is capable of forming a nitrogen-containing heterocyclic ring,

c) if required, a solvent,

d) if required, at least one surfactant and

e) if required, at least one dye.

Very particularly preferred pigment-free mixtures consist of

a) at least one optical brightener,

b) at least one (co)polymer which contains at least one nitrogen-containing heterocyclic ring and/or is capable of forming a nitrogen-containing heterocyclic ring,

c) if required, a solvent,

d) if required, at least one surfactant and

e) if required, at least one dye,

with the proviso that at least one surfactant d) and/or at least one dye e) are present.

According to the definition of CD Römpp Chemie Lexikon—Version 1.0, Stuttgart/New York: Georg Thieme Verlag 1995, surfactants d) are substances which reduce the surface tension. Thus, surface-active substances which may have an anionic, cationic, ampholytic or nonionic composition are included here.

These substances are known per se to a person skilled in the art and, according to the invention, are not restricted.

Dyes e) differ from the pigments in their solubility in the application medium, i.e. they have a solubility of greater than 1 g/l 000 g in the application medium at 25° C.

Examples of dyes are azo, azine, anthraquinone, acridine, cyanine, oxazine, polymethine, thiazine and triarylmethane dyes.

These dyes can be used in the form of basic or cationic dyes, mordant, direct, disperse, developed, vat, metal complex, reactive, acid, sulfur, coupling or substantive dyes.

Preferred dyes are reactive, direct, vat, sulfur, disperse, cationic and coupling dyes.

Particularly preferred dyes are those which are known as textile dyes to a person skilled in the art, i.e. are intended for dyeing fibers, yarns, woven fabrics and knitted fabrics.

These are, for example, dyes as described in Ullmann's Encyclopedia of Industrial Chemistry, Sixth Edition, 2000 Electronic Release, Textile Dyeing.

The novel mixtures are prepared by mixing the individual components with one another. The mixing sequence and the form in which the components are present, as solid, liquid, dispersion or solution, generally does not play a role.

It is possible, for example,

1) initially to take the (co)polymer b) preferably in the form of a solution, particularly preferably as an aqueous solution, and then

2) to add the optical brightener a) in the form of a solid, for example as a powder or granules, in the form of a solution, for example as an aqueous or alcoholic solution, or in the form of a slurry, for example as a suspension, for example in water or an alcohol, and

3) then, if desired, surfactant d) and/or dye e) with mixing.

If it is intended to obtain a solution, any solvent c) present may be added a little at a time or individually at any desired stage or used for dissolving or dispersing an individual component.

In a preferred embodiment, solutions of the optical brightener a) and of the (co)polymer b) in at least one solvent c) are mixed with one another and any desired other components d) and/or e), which in turn may likewise be present in the form of solutions, are added.

The solutions of a) and b) may be present in different solvents c) or preferably in the same solvent.

If it is intended to obtain a dispersion, the individual components can be dispersed by supplying the required energy.

The present invention furthermore relates to the use of the novel mixtures in washing agents, in particular if detergents or surfactants d) are present, if required in addition to other conventional additives known per se to a person skilled in the art for washing agents.

The present invention also relates to the use of the novel mixtures in dyeing, preferably according to the definition of CD Römpp Chemie Lexikon—Version 1.0, Stuttgart/New York: Georg Thieme Verlag 1995, with reference to DIN 61704 on “Treatment of woven fabrics and knitted fabrics in aqueous solutions or suspensions of dyes with additives”, and particularly preferably in textile dyeing.

ppm and percentage data used in this document relate to percentages by weight and ppm by weight, unless stated otherwise.

### EXAMPLES

The optical brighteners were used as stock solutions in a concentration of 2 g/l.

The (co)polymers were used as stock solutions in a concentration of 0.1 g/l.

5 ml of the stock solution of the optical brightener and an amount of the (co)polymer stock solution which gave the concentration stated in the table were mixed in a volumetric flask and made up to 50 ml with distilled water.

The fluorescence intensities of the standard solutions thus obtained and having a concentration of 0.2 mg/l of optical brightener and the (co)polymer concentration stated in the table were determined using a fluorescence spectrophotometer F-4500 from Hitachi.

The excitation wavelength was set at 338 nm, and the excitation gap and the emission gap were in each case fixed at 5 nm. The fluorescence intensity at 437 nm was measured in relative units in a 90° arrangement.

Comparative mixture 1: aqueous solution of Tinopal® ABP-Z from Ciba Specialty Chemicals

Comparative mixture 2: aqueous solution of Tinopal® SPP-Z from Ciba Specialty Chemicals

Comparative mixture 3: aqueous solution of Blankophor® PSG from Bayer AG

Comparative mixture 4: aqueous solution of Blankophor® BA from Bayer AG

Comparative mixture 5: aqueous solution of a polyethylenimine (Polymin® SK from BASF AG) and Tinopal® ABP-Z from Ciba Specialty Chemicals

Comparative mixture 6: aqueous solution of a completely hydrolyzed polyvinylformamide having a K value of 90 and Tinopal® SPP-Z from Ciba Specialty Chemicals

Mixture 1: aqueous solution of an unhydrolyzed polyvinylformamide having a K value of 30 and Blankophor® PSG from Bayer AG

Mixture 2: aqueous solution of a polyvinylformamide having a K value of 30 and a degree of hydrolysis of 4.6% and Blankophor® PSG from Bayer AG

Mixture 3: aqueous solution of an unhydrolyzed polyvinylformamide having a K value of 30 and Tinopal® SPP-Z from Ciba Specialty Chemicals

Mixture 4: aqueous solution of a polyvinylformamide having a K value of 30 and a degree of hydrolysis of 3.3% and Tinopal® SPP-Z from Ciba Specialty Chemicals

Mixture 5: aqueous solution of an unhydrolyzed polyvinylformamide having a K value of 30 and Tinopal® ABP-Z from Ciba Specialty Chemicals

Mixture 6: aqueous solution of a polyvinylformamide having a K value of 30 and a degree of hydrolysis of 3.3% and Tinopal® ABP-Z from Ciba Specialty Chemicals

Mixture 7: aqueous solution of an unhydrolyzed polyvinylformamide having a K value of 30 and Blankophor® BA from Bayer AG

Mixture 8: aqueous solution of a polyvinylformamide having a K value of 30 and a degree of hydrolysis of 4.5% and Blankophor® BA from Bayer AG

| | Concentration of | Fluorescence |
|---|---|---|
| Mixture | (co)polymer [mg/l] | intensity |
| Comparative mixture 1 | 0 | 40 |
| Comparative mixture 2 | 0 | 50 |
| Comparative mixture 3 | 0 | 50 |
| Comparative mixture 4 | 0 | 159 |
| Comparative mixture 5 | 10 | 40 |
| Comparative mixture 6 | 10 | 27 |
| Mixture 1 | 10 | 220 |
| Mixture 2 | 10 | 500 |
| Mixture 3 | 10 | 490 |
| Mixture 4 | 10 | 300 |
| Mixture 5 | 10 | 120 |
| Mixture 6 | 10 | 900 |
| Mixture 7 | 10 | 300 |
| Mixture 8 | 10 | 470 |

1: A pigment-free mixture comprising
a) at least one optical brightener and
b) at least one (co)polymer which contains at least one N-vinylcarboxamide incorporated in the form of polymerized units and/or contains at least one nitrogen-containing heterocyclic ring and/or is capable of forming a nitrogen-containing heterocyclic ring.

2: A pigment-free mixture as claimed in claim 1, wherein the nitrogen-containing heterocyclic rings are selected from the group consisting of pyridines, pyridazines, pyrazines, pyrimidines and the dihydro, tetrahydro and hexahydro derivatives thereof, imidazoles, pyrroles, pyrrolidines, pyrrolidones, pyrrolines (dihydropyrroles), 1H-, 3H- and 4H-pyrazoles, 1-, 2- and 3-pyrazolines, imidazolines, thiazoles, oxazoles, 1,2,4-triazoles and 1,2,3-triazoles.

3: A pigment-free mixture as claimed in claim 1, wherein the nitrogen-containing heterocyclic rings are selected from the group consisting of imidazoles, 2-pyrrolidones, pyrimidines and 3,4,5,6-tetrahydropyrimidines.

4: A pigment-free mixture as claimed in claim 1, wherein the (co)polymer contains N-vinylimidazole or N-vinylpyrrolidone incorporated in the form of polymerized units.

5: A pigment-free mixture as claimed in claim 1, wherein the (co)polymer b) contains the structural unit (II) 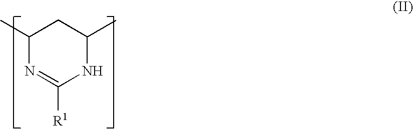
where
R¹ is hydrogen or C₁- to C₂₀-alkyl, it being possible for the alkyl radical to be straight-chain or branched.

6: A pigment-free mixture as claimed in claim 1, wherein the (co)polymer b) contains
i) at least one N-vinylcarboxamide
ii) if required, at least one water-soluble cationic monomer
iii) if required, at least one further monomer incorporated in the form of polymerized units.

7: A pigment-free mixture as claimed in claim 6, wherein the (co)polymer b) contains N-vinylformamide incorporated in the form of polymerized units and this is partly cleaved.

8: A pigment-free mixture as claimed in claim 6, wherein the (co)polymer b) contains 100% by weight of N-vinylformamide incorporated in the form of polymerized units and this is uncleaved or partly cleaved.

9: A pigment-free mixture as claimed in claim 1, comprising
a) at least one optical brightener,
b) at least one (co)polymer which contains at least one nitrogen-containing heterocyclic ring and/or is capable of forming a nitrogen-containing heterocyclic ring,
c) if required, a solvent,
d) if required, at least one surfactant and
e) if required, at least one dye.

10: The use of a pigment-free mixture as claimed in claim 1 in dyeing or in washing agents.

11: A dyeing or washing agent, which comprises: the pigment-free mixture as claimed in claim 1.
